(19) United States
(12) Patent Application Publication
(10) Pub. No.: US 2008/0086475 A1
(43) Pub. Date: Apr. 10, 2008

(54) INTERNET MEMORY WEBSITE

(76) Inventor: Brendan Kane, Los Angeles, CA (US)

Correspondence Address: SCHIFF HARDIN, LLP;PATENT DEPARTMENT, 6600 SEARS TOWER, CHICAGO, IL, 60606-6473, US

(21) Appl. No.: 11/870,027

(22) Filed: Oct. 10, 2007

Related U.S. Application Data
(60) Provisional application No. 60/850,703, filed on Oct. 10, 2006.

(51) Int. Cl. G06F 17/30

(52) U.S. Cl. 707/9; 707/204; 707/E17.005; 707/E17.116

(57) ABSTRACT

A website is operated by a first party and electronically hosts a personal web page of a second party and other personal web pages of a plurality of third parties. The second and third parties are enabled to electronically access their respective personal web pages, and the first, second, and third parties are separate parties. The second party may instruct the website to archive at least a section of a current version of the personal web page of the second party, in which case the website archives at least the section of the personal web page of the second party. The website permits electronic updating of the personal web page of the second party without changing the archived section of the personal web page of the second party.

### RELATED APPLICATIONS

The present application claims the benefit of U.S. Provisional Application Ser. No. 60/850,703 filed on Oct. 10, 2006.

### TECHNICAL FIELD

The present application discloses an internet website that can be used to store a user's memories.

### BACKGROUND

People consider memories among their most cherished and valued possessions. Today people rely upon photos, videos, letters, and diaries to preserve their memories. Because of their intrinsic value, people want to protect, store, and access their memorable assets at any time.

Currently, social networks (such as MySpace, YouTube, Facebook, Flickr) are the most popular internet places to store and share personal experiences. Howeveer, these social networks do not permit the archiving of memories. These social network systems do not provide the user with the ability to save copies of the current versions of their social network page so that the users can later retrieve those memories. Instead, these social networks only offer users the ability to update their web pages. Accordingly, it is not currently possible for 2015 social network users to look back at the videos, images, friends and comments on their 2007 social network pages (unless the 2007 pages had never been updated during the years 2007 to 2015).

Also, current social network users are not able to divide theirs web pages between private or public portions. Current social network users can only make their entire web pages either private or public. If the private option is currently chosen, then the entire web page will not be visible to others and no one will know the content of the web page even exists.

Moreover, current social networks permit users to associate icon photos with their current friends. However, these social networks do not provide users with the option of archiving the icon photos. Instead, in current social networks, the icons that represents friends change each time that the friends update their profile photo.

The memory web page and/or memory website disclosed herein solves one or more of these or other problems.

### BRIEF DESCRIPTION OF THE DRAWING

These and other features and advantages will become more apparent from the detailed description below when taken in conjunction with the drawings in which:

FIG. 1 is a block diagram useful in explaining various embodiments of the present invention;

FIG. 2 illustrates a computer that can be used in connection with each of the nodes of FIG. 1;

FIGS. 3A and 3A illustrate a flow chart representing the operations of the users of FIG. 1; and,

FIG. 4 illustrates a flow chart representing operations of the memory website of FIG. 1.

### DETAILED DESCRIPTION

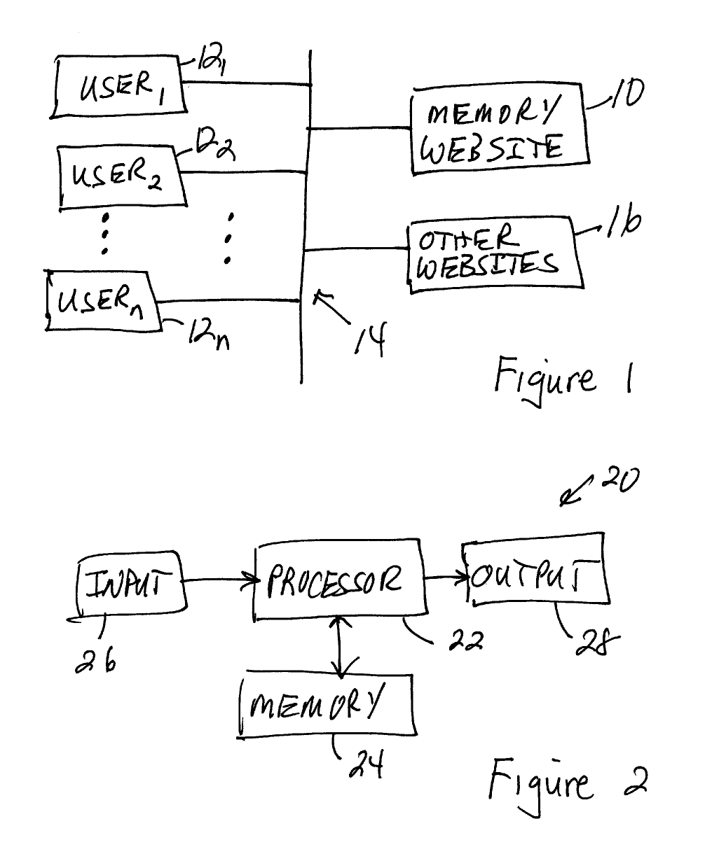

One example of an implementation of an Internet memory website is presented in FIG. 1. As shown in FIG. 1, a memory website 10 and a plurality of users 12₁, 12₂, . . . , 12ₙ are interconnected by a communications medium 14 such as the Internet. Also, other websites 16 are likewise interconnected with the memory website 10 and the plurality of users 12₁, 12₂, . . . , 12ₙ by the communications medium 14. Each of the memory website 10, the users 12₁, 12₂, . . . , 12ₙ, and the other websites 16 will be understood to include one or more computers having access to the communications medium 14.

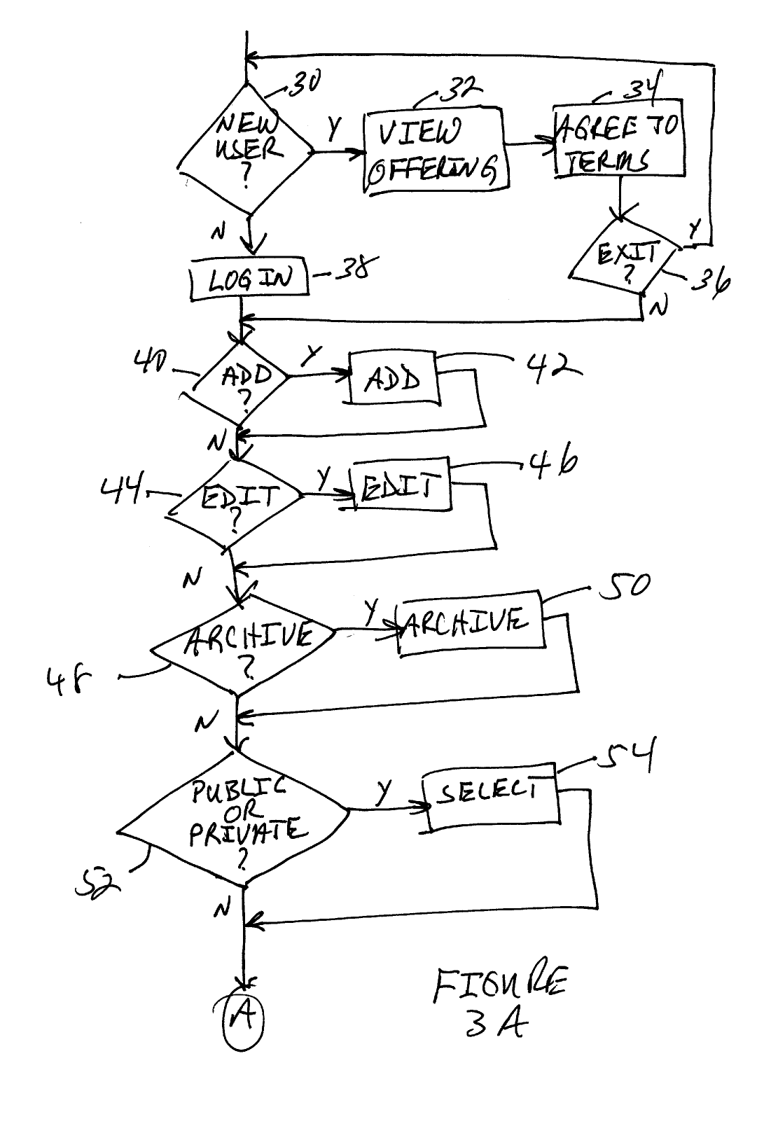

A representative computer 20 is shown in FIG. 2 and can be used at the memory website 10, the users 12₁, 12₂, . . . , 12ₙ, and/or the other websites 16. The computer 20 includes a processor 22, a memory 24, an input device(s) 26, and an output device (s) 28.

The input device (s) 26 may be a mouse, a keyboard, etc. capable of inputting data to the processor 22. The input device(s) 26 may be used to make selections and data so as to create, amend, and/or maintain a memory web page.

The output device(s) 28 may be a monitor, a printer, etc. capable of displaying memory web pages, offerings, and/or other information associate with the creation, amendment, and/or maintenance of memory web pages.

The memory 24 stores data and programs necessary to create, amend, and/or maintain memory web pages.

In one embodiment, the memory website 10 allows the users 12₁, 12₂, . . . , 12ₙ, who may be individuals, groups of friends, entire families, or any other group, to create a memory web page that can be used to organize and store all of their memories so that these memories can be shared with others and/or can be kept for private use. The memory website 10 contains innovative functions and tools that help the users 12₁, 12₂, . . . , 12ₙ to design and capture a clear, vivid representation of their memories. When the users 12₁, 12₂, . . . , 12ₙ sign up for their memory web pages hosted by the memory website 10, the users 12₁, 12₂, . . . , 12ₙ are provided with a customizable website platform to help them categorize all of their stored videos, pictures, news clippings, music, and/or other memorable assets. The users 12₁, 12₂, . . . , 12ₙ are able to easily personalize their memory web pages (e.g., change colors, move, add, and/or delete sections, create different category names for each section, etc.) to best capture the experiences and feelings of a particular time in the user's life.

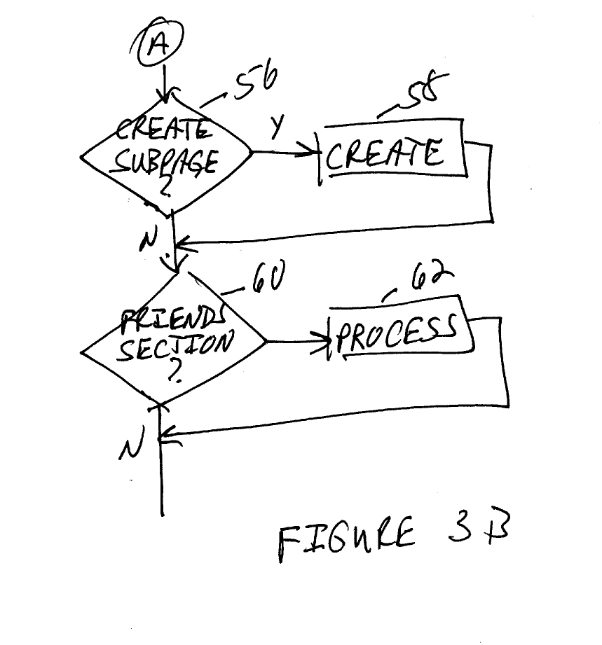

FIGS. 3A and 3B present a flow chart representing program code that executes on the computers of the users 12₁, 12₂, . . . , 12ₙ. Accordingly, when the user 12₁, for example, accesses the memory website 10, the user 12₁ indicates at 30 whether the user 12₁ is a new user, for example, by selecting a new user button on a screen displayed by the output device of the user's computer. If the user 12₁ is a new user, the user 12₁ at 32 views an offering associated with setting up and maintaining a memory web page hosted by the memory website 10. This offering may include payment terms offered by the memory website 10 for providing the memory web page service. If the user 12₁ agrees to the terms of the offer at 34, the user 12₁ may also be asked at 34 to provide a user name and a password so that only the user 12₁ can add to, edit, archive, etc. the memory web page of the user 12₁.

Once the user 12₁ has agreed to the terms at 34, the user 12₁ may choose at 36 to exit the memory website 10. If the user 12₁ chooses not to exit the memory website 10, or if the user 12₁ indicates at 30 that the user 12₁ is a not new user, the user 12₁ at 38 logs into the memory website 10. The user 12₁ may then elect at 40 to create and/or add items at 42 to the memory web page of the user 12₁, and/or the user 12₁ may elect at 44 to edit the memory web page at 46, and/or the user 12₁ may elect at 48 to archive the current version of the memory web page at 50. This archive feature allows the user 12₁ to direct the memory website 10 to archive each version of the memory web page of the user 12₁ as the user 12₁ chooses. Thus, user 12₁ is able to create and preserve memory web pages corresponding with different periods and/or events in the life of the user 12₁.

The user 12₁ may also elect at 52 to designate at 54 one or more sections of the memory web page of the user 12₁ as private. Therefore, the section(s) of the memory web page of the user 12₁ designated as private is available to viewing by only the user 12₁, such that visitors to the memory web page of the user 12₁ have access to only the remaining sections not designated as private. Alternatively or additionally, the user 12₁ may be allowed to elect at 52 to designate at 54 one or more sections of the memory web page of the user 12₁ as public, with the understanding that all other sections not so designated are private sections. Accordingly, if the private option is chosen for a particular section on the memory web page, then the entire chosen section will not be visible to others and no one will know that section even exists. This election is a useful tool for, say, diaries.

The user 12₁ also has the ability to choose at 56 to create detailed subpages at 58. The user 12₁ can create at 58 a subpage at 58 for each age, a subpage for a series of years, such as high school, subpages for major events such as a graduations or weddings, etc. For example, if the user 12₁ were to fully utilize the subpage feature, the memory web page of the user 12₁ might look like the following:
Page 1: Ages 1-10
Page 2: Ages 11-14
Page 3: Freshman year high school
Page 4: Sophomore and junior year high school
Page 5: Senior year high school
Page 6: High school graduation
Page 7: College
Page 8: Wedding and anniversaries
Page 9: First child's birth (at this point the user can create a new memory website for her child)

The subpage feature also can be an extremely effective organizational tool to chronicle memories. At anytime the user can quickly and easily access specific memories and experiences, as opposed to locating and digging through a drawer or shoeboxes for hours only to find a few unlabeled pictures.

Another innovative feature provided by the memory website 10 allows the users 12₁, 12₂, . . . , 12ₙ to select at 60 a “friends” section of the memory web page. If selected, the users 12₁, 12₂, . . . , 12ₙ at 62 can list and categorize friends by the particular year or time period of their relationships. Each friend on the list can be represented by pictures, videos, and/or simple text. At 62, the users 12₁, 12₂, . . . , 12ₙ can archive icon photos of their friends in order to preserve the memories of those friends from specific years. Thus, these icon photos can be updated before they are updated and thereby lost. The friends section can also be used to let the users 12₁, 12₂, . . . , 12ₙ keep track of their friends' ever-changing contact information.

Thus, the memory website 10 provides the users 12₁, 12₂, . . . , 12ₙ with a tool to organize all of their memorable assets—photo, videos, letters, etc.—in order to review or retrieve these memorable assets at anytime. Once a memory web page at the memory website 10 is created, it can be accessed or updated at anytime.

The users 12₁, 12₂, . . . , 12ₙ can post videos, letters, comments, posters, pictures, and/or any type of media that relates to themselves, their friends or family on their memory web pages. Each memory web page can also be split into different categorized pages, such as by age, year, decade, event, or school. For example, the users 12₁, 12₂, . . . , 12ₙ can create pages for every year of their lives, and the pages will contain those assets that relate to experiences, relationships, events, etc. that occurred during that year. Each memory web page can be created at anytime, it can be created as soon as these assets are made available, or it can be created twenty years later. Therefore, parents can start a memory website for their children as soon as the children are born, or a 60 year old person can retroactively create a memory web page that looks back on the person's life.

Once the assets are organized and stored, each memory web page contains the tools allowing an individual to take all of the individual's assets and to edit them at 46 in any desired way. For example, the individual could edit all of the individual's home movies into a video montage of the individual's life, or the individual could take all of the individual's photo assets and create a picture presentation such as a slide show.

Memory web pages can also be created at 42 for an entire family or for a group of friends. For example, a family can start a family tree through its memory web page, uploading its memory assets each year, so that future generations of that family can look back and see their long line of relatives and witness their experiences and interests. It will be interesting for a person to look back on a relative's memory web page long after the relative has passed away, especially if the person never knew the relative. A group of high school friends can also create a page so that they can always remember the experiences they shared or so that they can remember what they were like at a specific age. Sororities or fraternities can also create a page for each of their classes.

A memory web page can also be created at 42 for one special event, such as a wedding or graduation, which will allow people who attended the event to always look back on it. A school can create a memory website for each graduating class so that graduates can always access assets, such as videos and pictures, from their graduation.

Sports teams can create a memory web page for themselves and their fans, so that their fans can look back on the history and important events involving the teams.

The individual or group who creates a memory web page can allow people visiting the memory web page to leave comments, emails, messages, etc. Also, individuals or groups can connect with other people who have created memory web pages and communicate with them and even trade assets.

The business model for the memory website 10 can be subscription based, where individuals or groups pay a yearly or monthly fee. If the subscription is not renewed, all of the assets for that particular memory website will still be stored, but the assets will not be accessible until the subscription has been renewed.

There can also be a section on the memory website 10 where the users 12₁, 12₂ , . . . , 12ₙ can access media related to a specific time period and place it on their memory web pages. For example, there could be media (a poster, picture, or short video) representing the most popular movie and TV shows for each year, and people will be able to take that media and place it on their memory websites. Such media could be hosted on the memory website 10 and/or on the other websites 16. This feature allows the users 12₁, 12₂, . . . , 12ₙ to remember their favorite TV shows or movies at that particular time in their lives. Also, various songs from a specific time period can be made available to store on their memory web pages as well.

There can also be a reminder feature provided by the memory website 10 where the users 12₁, 12₂, . . . , 12ₙ or groups who created the memory web pages can request a reminder to be sent to them via email, phone, etc., to remind them to update their memory web pages. The primary function of these reminders is to help the users 12₁, 12₂, . . . , 12ₙ keep their memory web pages current.

The memory web page can be used to organize and store memorable asset, to look back and remember past experiences, friends, family, events, etc. by looking at memorable assets, to share memorable assets with other people chosen by the creator of the memory web page, to access the memorable assets at anytime, to create copies of memorable assets at anytime, etc. For example, the users 12₁, 12₂, . . . , 12ₙ can upload their photos now, and five years down the road they can come back and print those same pictures from their memory web page. Or, the users 12₁, 12₂, . . . , 12ₙ can burn the videos they have uploaded to DVD and are provided with the tools to take their memorable assets and create a video montage, picture presentation, etc.

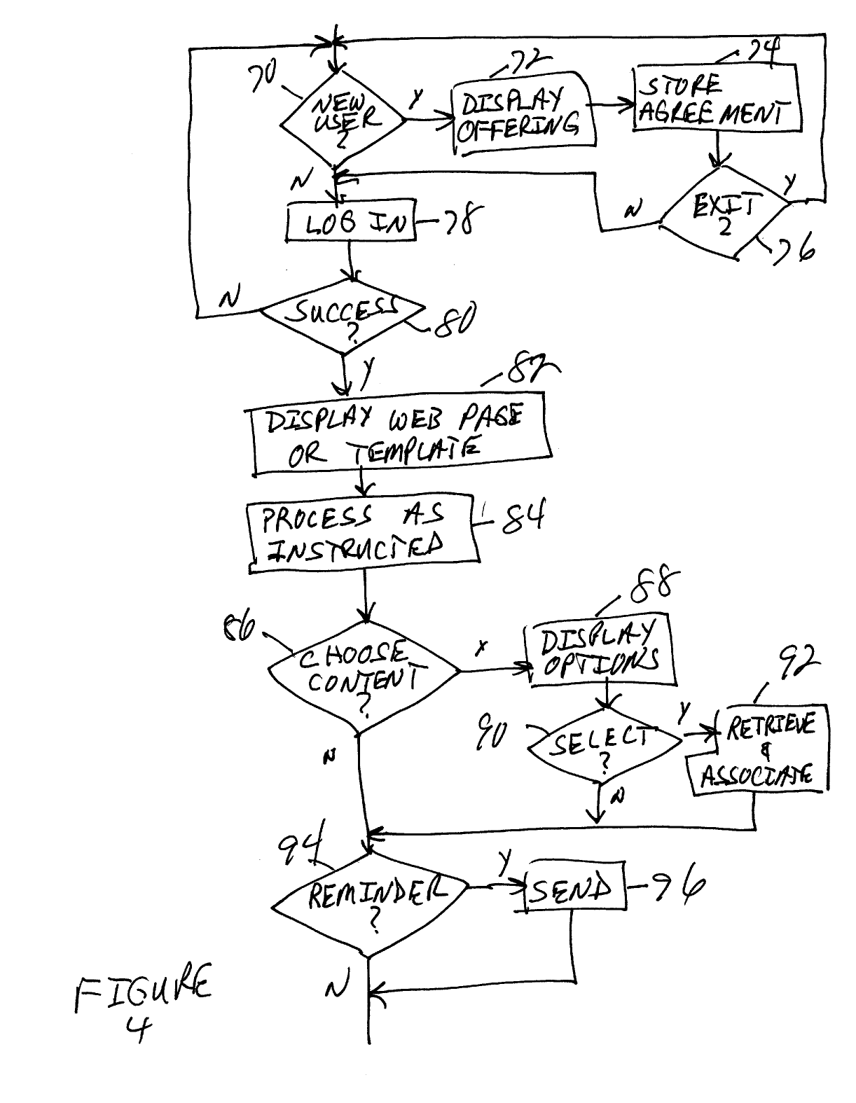

FIG. 4 presents a flow chart representing program code that executes on the computer(s) of the website 10. Accordingly, when the user 12₁, for example, visits the memory website 10, the memory website 10 determines at 70 whether the user 12₁ is a new user, for example, by the user 12₁ selecting a new user button on a screen provided by the memory website 10. If the user 12₁ is a new user, the memory website 10 at 72 displays an offering associated with setting up and maintaining a memory web page hosted by the memory website 10. This offering may include payment terms offered by the memory website 10 for providing the memory web page service. If the user 12₁ agrees to the terms of the offer at 34, the memory website 10 stores the agreement, arranges payment terms, and schedules future payment reminders at 74. At 74, the memory website 10 can also lead the user 12₁ through setting up a user name and a password so that only the user 12₁ can add to, edit, archive, etc. the memory web page of the user 12₁.

Once processing at 74 is completed, the memory website 10 gives the user 12₁ the choose at 76 to exit the memory website 10. If the user 12₁ chooses not to exit the memory website 10, or if the memory website 10 determines at 70 that the user 12₁ is a not new user, the memory website 10 prompts the user 12₁ at 78 to log into the memory website 10.

If the memory website 10 determines at 80 that the log in is successful, the memory website 10 displays the web page of subpages to the user 12₁ as the user 12₁ desires. The memory website 10 might also display instructions and/or a template of a web page for a first time user to help the first time user to get started with the creation of a memory web page. At 84, the memory website 10 permits the user 12₁ to perform operations on the memory web page as described above. Thus, the user 12₁ may create and/or add items to the memory web page of the user 12₁, and/or the user 12₁ may edit the memory web page, and/or the user 12₁ may archive the current version of the memory web page.

At 84, the user 12₁ may also elect to designate one or more sections of the memory web page of the user 12₁ as private. Therefore, the section(s) of the memory web page of the user 12₁ designated as private is made available by the memory website 10 to viewing by only the user 12₁, such that visitors to the memory web page of the user 12₁ have access to only the remaining sections not designated as private. At 84, the memory website 10 also provides the user 12₁ with the ability to create detailed subpages and to establish a “friends” section of the memory web page.

At 86, the memory website 10 permits the users 12₁, 12₂, . . . , 12ₙ to choose to associate content such as media with their memory web pages. If the users 12₁, 12₂, . . . , 12ₙ choose at 86 to associate content with their memory web pages, the memory website 10 at 88 displays at 88 various options to the users 12₁, 12₂, . . . , 12ₙ. These options may include, for example, to select content from the memory website 10, to select content from the other websites 16, to select specific content from either website, etc. If the users 12₁, 12₂, . . . , 12ₙ selects an appropriate option at 90, the memory website 10 at 92 retrieves the chosen content either internally or from the other websites 16.

At 94, the memory website 10 determines whether a reminder should be sent to any of the users 12₁, 12₂, . . . , 12ₙ. If it is time to send a reminder to any of the users 12₁, 12₂, . . . , 12ₙ, the memory website 10 at 96 sends the reminder at 96. As discussed above, this reminder may be a subscription renewal reminder. Additionally or alternatively, this reminder my be a reminder to the users 12₁, 12₂, . . . , 12ₙ to remind them to update their memory web pages.

Accordingly, the memory web pages of the users 12₁, 12₂, . . . , 12ₙ are hosted by the memory website 10 which permits the users 12₁, 12₂, . . . , 12ₙ to create, store, edit, access, archive, etc. their memory web pages or versions thereof.

Certain modifications of the present invention have been discussed above. Other modifications will occur to those practicing in the art of the present invention. For example, the flow charts described herein need not represent a serial logic flow and instead may be considered to alternatively represent a parallel logic flow such as that resulting from an event initiated program.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

I claim:

1. A method performed by a web accessible computer of a first party comprising:
electronically accessing a website operated by a second party, wherein the website hosts a first personal web page of the first party and other personal web pages of a plurality of third parties such that the first and third parties are enabled to electronically access their respective personal web pages, wherein the first, second, and third parties are separate parties;
electronically instructing the second party to archive at least a section of a current version of the first personal web page; and,
electronically updating the first personal web page so that the archived section of the first personal web page remains unchanged.

2. The method of claim 1 wherein the archived section of the current version of the first personal web page comprises an icon photo of a friend of the first party.

3. The method of claim 1 wherein the electronically instructing of the second party to archive at least a section of a current version of the first personal web page comprises electronically instructing the second party to archive the current version of the first personal web page, and wherein the electronically updating of the first personal web page so that the archived section of the first personal web page remains unchanged comprises electronically updating the first personal web page so that the archived first personal web page remains unchanged.

4. A method performed by a web accessible computer of a first party comprising:
electronically accessing a website operated by a second party, wherein the website hosts a first personal web page of the first party and other personal web pages of a plurality of third parties such that the second and third parties are enabled to electronically access their respective personal web pages, wherein the first, second, and third parties are separate parties; and,
electronically instructing the second party to restrict electronic access by certain users to a restricted section of the first personal web page such that the certain users are permitted electronic access to an unrestricted section of the first personal web page.

5. A method performed by a web accessible computer of a website operated by a first party comprising:
electronically hosting a personal web page of a second party and other personal web pages of a plurality of third parties such that the second and third parties are enabled to electronically access their respective personal web pages, wherein the first, second, and third parties are separate parties;
electronically receiving an instruction from the second party to archive at least a section of a current version of the personal web page of the second party;
archiving at least the section of the personal web page of the second party in response to the instruction; and,
permitting electronic updating of the personal web page of the second party without changing the archived section of the personal web page of the second party.

6. The method of claim 5 wherein the archived section of the current version of the personal web page of the second party comprises an icon photo of a friend of the second party.

7. The method of claim 5 wherein the electronically receiving of an instruction from the second party to archive at least a section of a current version of the personal web page of the second party comprises electronically receiving an instruction from the second party to archive the current version of the personal web page of the second party, wherein the archiving of at least the section of the personal web page of the second party in response to the instruction comprises archiving the personal web page of the second party in response to the instruction, and wherein the permitting of electronic updating of the personal web page of the second party without changing the archived section of the personal web page of the second party comprises permitting electronic updating of the personal web page of the second party without changing the archived personal web page of the second party.

8. A method performed by a web accessible computer of a website operated by a first party comprising:
electronically hosting a personal web page of a second party and personal web pages of a plurality of third parties such that the second and third parties are enabled to electronically access their respective personal web pages, wherein the first, second, and third parties are separate parties; and,
electronically receiving an instruction from the second party to restrict electronic access by certain users to a restricted section of the personal web page of the second party such that the certain users are permitted electronic access to an unrestricted section of the personal web page of the second party; and,
in response to the instruction, restricting electronic access to the restricted section of the personal web page of the second party thereby prohibiting the certain users from accessing the restricted section of the personal web page of the second party.
